(19) United States
(12) Patent Application Publication
(10) Pub. No.: US 2023/0362468 A1
(43) Pub. Date: Nov. 9, 2023

(54) OPTICAL SENSOR SYSTEM AND MOTOR VEHICLE HAVING AN OPTICAL SENSOR SYSTEM

(71) Applicant: Dr. Ing. h.c. F. Porsche Aktiengesellschaft, Stuttgart (DE)

(72) Inventors: Simon Isele, Stuttgart (DE); Stefan Roos, Kieselbronn (DE); Lukas Ewecker, Stuttgart (DE)

(21) Appl. No.: 18/143,210

(22) Filed: May 4, 2023

(30) Foreign Application Priority Data
May 9, 2022 (DE) 10 2022 111 485.6

(51) Int. Cl. H04N 23/55; H04N 23/12

(52) U.S. Cl. CPC H04N 23/55; H04N 23/12

(57) ABSTRACT

An optical sensor system (1) has plural optical lens systems (2a-2n), a single imaging optical sensor (3) and plural light guides (4a-4n) corresponding to the number of optical lens systems (2a-2n). The light guides (4a-4n) extend respectively between the lens systems (2a-2n) and the optical sensor (3). Each of the lens systems (2a-2n) is associated respectively with one of the light guides (4a-4n). A switching apparatus (5) selectively switches between the light guide means (4a-4n).

### CROSS REFERENCE TO RELATED APPLICATION

This application claims priority on German Patent Application No 10 2022 111 485.6 filed May 9, 2022, the entire disclosure of which is incorporated herein by reference.

### BACKGROUND

Field of the Invention. The invention relates to an optical sensor system that can be used in a motor vehicle.

Related Art. Known motor vehicles have camera devices to sense the motor vehicle environment and to detect obstacles in the vehicle environment. Such camera devices have lens system and an imaging optical sensor, such as a CMOS or CCD sensor. Light signals pass through the lens system and impinge on the optical sensor. These light signals are processed immediately by the optical sensor such that the light signals are converted into computer-readable images.

Autonomously driving motor vehicles operate primarily on the basis of camera images captured by the camera equipment and evaluated by a vehicle control device. Current systems use multiple individual camera devices connected to the vehicle control device via wiring. System architectures with multiple camera devices, process very large amounts of data depending on the image resolution and the refresh frequency (e.g., images in HD resolution with a refresh frequency of 30 Hz). These large amounts of data must be transmitted via wiring from the optical sensors of the individual camera devices and then must be received and processed by the vehicle control device. This approach results in problems due to the required data transferring rate and due to the amount of data that must be processed. Installation space available in a motor vehicle for the recording of the camera equipment is limited and leads to limitations of the image resolution and the imaging optical sensors.

The camera equipment used in driver assistance systems require a synchronization strategy and a common shuttering process when simultaneously requesting multiple camera images for further processing. These requirements can be met only with a relatively large effort.

EP 2 182 718 A1 and from U.S. Pat. No. 7,171,088 B2 disclose optical sensor systems to remedy some of the problems mentioned above by using a single optical sensor means as well as multiple lens systems and a light guide means associated therewith. These optical sensor systems have light guides representing individual lens perspectives of the lens systems arranged in different positions and directed into subareas of the imaging optical sensor. As a result, all camera perspectives and images can be evaluated in real-time synchrony. However, the image quality is limited because each lens system can use only one subarea of the optical sensor means, so the image resolution is reduced accordingly.

The invention aims to provide an optical sensor system that produces high quality digital images and yet reduces computational and wiring complexities.

### SUMMARY

An optical sensor system according to this disclosure comprises switching means for selectively switching between light guide means.

The optical system disclosed herein is configured so that the camera positions required in an automobile or other applications are equipped with only a lens system, but not with their own optical sensor means. Each of these lens systems transmits bundled light signals to a processing device, in particular a central control device of a motor vehicle that is equipped with the optical sensor means. Light signals received by the control device are processed using a light guide means. As a result, the conversion of light signals into computer-readable images is performed centrally and only by way of a single optical sensor means. The optical sensor means can be exploited optimally, and one of the lens systems forming the light source (camera position) can be selected, as needed, at a consistent high image resolution and computing power. The optical sensor system comprises only a single optical sensor means and can be switched between the individual light guide means using the switching means. Thus, no additional optical sensor means is required for each of the lens systems, thereby leading to significant cost benefits. Furthermore, additional wiring effort between the lens systems and the processing device advantageously is eliminated. Moreover, the optical sensor system disclosed herein reduces computational power and energy because the switching means connects individual lens systems as needed, and simultaneous evaluation of the light signals of all lens systems of the optical sensor system is not needed.

In one embodiment, the switching means and the optical sensor means are integrated on a microchip.

The switching means can be integrated with the light guide means.

The light guide means of some embodiments is flexible to simplify positioning of the light guide means from the lens systems to the optical sensor means. These flexible light guide means can be fiber optic cables that direct the light signals in real time from the distributed positions of the lens systems to the processing device, in particular to the central control device.

The invention also relates to a motor vehicle comprising at least one optical sensor system as disclosed herein.

The lens systems of the optical sensor system can be positioned in a spatially optimized manner because the design space to be provided in the motor vehicle can be reduced given the elimination of an optical sensor means for each of the lens systems. In addition, no electrical wiring is required for digital data transfer from the lens systems to the processing device, in particular the central control device. The central optical sensor means provided for all lens systems can be utilized in full size so that a better full-sized digital image from the optical sensor means can be calculated. Switching between the individual light guide means, and thus between the lens systems representing different camera perspectives, is performed in a simple manner using the switching means.

Further features and advantages of the invention will become apparent from the following description of a preferred embodiment with reference to the FIGURE.

### BRIEF DESCRIPTION OF THE DRAWING

FIG. 1 is a highly schematic illustration of an optical sensor system in accordance with an embodiment of the invention.

### DETAILED DESCRIPTION

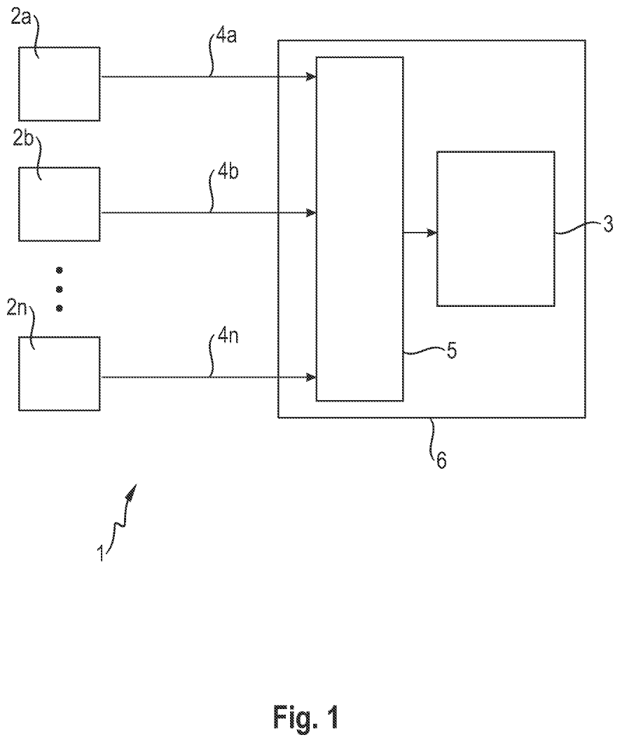

An optical sensor system in accordance with an embodiment of this disclosure is illustrated schematically in FIG. 1 and can be installed, for example in a motor vehicle. Numerous other areas of application for the optical sensor system 1 are also conceivable.

The optical sensor system 1 comprises a number n 2 of optical lens systems 2a-2n, a single imaging optical sensor means 3, and a number of light guide means 4a-4n corresponding to the number of optical lens systems 2a-2n. The light guide means 4a-4n extend between the lens systems 2a-2n and the optical sensor means 3 so that each of the lens systems 2a-2n is associated respectively with one of the light guide means 4a-4n.

Each of the lens systems 2a-2n comprises at least one lens as a light refracting element. Depending on the intended use, the lens systems 2a-2n also can comprise multiple lens means arranged within an optical beam path. Further, in addition to the at least one lens means, at least some of the lens systems 2a-2n can comprise further optically functional means that have an impact on the light passing through the respective lens system. For example, such optically functional means can be color filters.

The optical lens systems 2a-2n are arranged during assembly of the optical sensor system 1 at those positions of the motor vehicle in which image data, in particular image data for driving assistance systems, is intended to be acquired during operation. The light guide means 4a-4n may be flexible fiber optic cables that can be positioned very easily between the lens systems 2a-2n and the optical sensor means 3. These flexible light guide means 4a-4n direct the light signals in real time from the distributed positions of the lens systems 2a-2n to the optical sensor means 3 that preferably is an integrated part of a processing device, in particular a central control device. The optical sensor means 3 is designed to process the light signals received and to generate a computer-readable image therefrom. A “processing device” can be understood in connection with the invention to mean, for example, a machine or an electronic circuit. In particular, a processor may be a master processor (central processing unit (CPU)), a microprocessor, or a microcontroller, for example an application-specific integrated circuit or a digital signal processor, optionally in combination with a memory unit for storing program instructions, etc. A processing device may also be understood to mean a virtualized processor, a virtual machine, or a soft CPU. For example, it may also be a programmable processor equipped with configuration steps for carrying out the above-mentioned method according to the invention or configured with configuration steps in such a way that the programmable processor realizes the features according to the invention of the method, the component, the modules, or other aspects and/or partial aspects of the invention.

The optical sensor system 1 comprises switching means 5 for selectively switching between the light guide means 4a-4n. The light signals of the lens systems 2a-2n transmitted by the light guide means 4a-4n are processed sequentially using the optical sensor means 3 because the switching means 5 ensures that only the light signals transmitted by one of the light guide means 4a-4n are detected and processed by the optical sensor means 3 at any given time. In the illustrated embodiment, the switching means 5 and the optical sensor means 3 are designed to be integrated on a microchip 6. In an alternative embodiment, the option exists for the switching means 5 to be designed to be integrated with the light guide means 4a-4n.

The optical sensor means 3 and one of the lens systems 2a-2n representing the light source (camera position) can be selected at a consistent image resolution and computing power as needed. Given that the optical sensor system 1 comprises only a single optical sensor means 3 and can be switched by the switching means 5 between the individual light guide means 4a-4n, no additional optical sensor means is required for each of the lens systems 2a-2n. As a result, additional wiring effort between the lens systems 2a-2n and the control device advantageously is eliminated. Further, the optical sensor system 1 disclosed herein saves computing power and energy because the individual lens systems 2a-2n are switched on as needed by the switching means 5, so it is not necessary to evaluate the light signals of all lens systems 2a-2n simultaneously.

1. An optical sensor system (1), comprising:
plural optical lens systems (2a-2n);
a single imaging optical sensor means (3);
plural light guide means (4a-4n) corresponding in number to the plural optical lens systems (2a-2n), the plural light guide means (4a-4n) extending respectively between the lens systems (2a-2n) and the optical sensor means (3); and
switching means (5) designed to selectively switch between the light guide means (4a-4n).

2. The optical sensor system (1) of claim 1, wherein the switching means (5) and the optical sensor means (3) are integrated on a microchip (6).

3. The optical sensor system (1) of claim 1, wherein the switching means (5) is integrated with the light guide means (4a-4n).

4. The optical sensor system (1) of claim 1, wherein at least one of the plural light guide means (4a-4n) is flexible.

5. A motor vehicle comprising the optical sensor system (1) of claim 1.
